(19) United States
(12) Patent Application Publication
(10) Pub. No.: US 2012/0252367 A1
(43) Pub. Date: Oct. 4, 2012

(54) Auditory Speech Module For Medical Devices

(75) Inventors: Salvatore Gaglio, Pennington, NJ (US); Daniel Williams, Rock Hill, SC (US)

(73) Assignee: MEDITALK DEVICES, LLC, Fort Mill, SC (US)

(21) Appl. No.: 13/436,510

(22) Filed: Mar. 30, 2012

Related U.S. Application Data
(60) Provisional application No. 61/471,385, filed on Apr. 4, 2011.

(51) Int. Cl. H04B 7/00; G10L 11/00

(52) U.S. Cl. 455/66.1; 704/270.1; 704/E11.001

(57) ABSTRACT

The invention relates to a light, compact, and integrated speech module for attaching to a medical device and providing an auditory component to the device. The speech module comprises an audible signal generator, a recording means for recording data virtually simultaneously with daily activities stored for later viewing, a port or a connector for interchangeably connecting the module to the medical device, an on/off switch to start or stop the module operation, a switch to control the volume, and a switch to repeat the message emitted from the speaker.

### CROSS-REFERENCE TO RELATED APPLICATIONS

This utility application claims priority from provisional patent application No. 61/471,385 filed on Apr. 4, 2011 titled Auditory Speech Module For Medical Devices, the entirety of which is incorporated herein by reference.

### TECHNICAL FIELD

The field of the invention generally relates to interchangeable, light, compact, convenient, and reliable auditory speech modules comprising an auditory signal generator and optionally a recorder. The module is capable of being used independently with various glucose meters. The module attaches firmly to the glucose meter forming a single reliable unit and can provide male and female voice enunciation. The speech module includes a microprocessor configured to receive data from the glucose meter and transfer the data to the auditory signal generator for processing to give an auditory meter reading in a convenient format. The invention further relates to a method for using the audio device with various medical devices.

### BACKGROUND

The instant invention relates to a speech module with an auditory signal generator which can be plugged to a medical device and provide instructions and results to the user aloud. The speech module includes a microprocessor configured to receive and store data from the attached medical device, an auditory signal generator configured to convert the received data relevant to the patient, specifically for diabetes management; into auditory signals in order to enable the patient to self-evaluate the correlation between the inputted data and the patient's recorded blood glucose level. The speech module further optionally incorporates a means for recording data.

Diabetes mellitus, commonly referred to as diabetes, is a chronic disease in which an individual's blood glucose levels become abnormally high due to an inability to break down glucose. The hormone insulin is responsible for regulating glucose levels in the blood. Diabetics either produce an insufficient amount of insulin (Type I Diabetes or juvenile diabetes) to break down the glucose present in blood or are resistant to insulin and therefore cannot use it properly (Type 2 Diabetes). An estimated 17 million individuals in the United States have diabetes, with almost 1 million new cases being diagnosed each year.

Diabetes is known to cause damage to the small and large blood vessels, lead to diabetic blindness, kidney disease, amputation of limbs, stroke, and heart disease. According to the U.S. Centers for Disease Control and Prevention, more than 3 million Americans who have diabetes are visually impaired.

Self-monitoring of one's blood glucose has been determined to be an effective tool to manage diabetes. Self-monitoring of one's blood glucose is recommended by the FDA for all people with diabetes. It is recognized that self-monitoring of blood glucose will allow the user to: (1) keep track of their blood glucose levels over time, (2) make day-to-day decisions for managing glucose, (3) recognize emergency situations, and (4) be educated on how to manage their blood glucose levels. An estimated 8% of the 17 million American currently suffering from diabetes monitor their blood glucose at home. Checking one's blood glucose level allows a physician and/or individual to determine how much insulin should be taken to maintain normal blood glucose levels. The amount of glucose a diabetic requires will likely vary with age, a change in diet or lifestyle, stress or illness. It is therefore necessary for a diabetic to periodically check his or her glucose levels to ensure they are taking the proper amount of insulin and to render changes to diet, exercise and the like to improve management and longevity.

Many factors can cause one's blood glucose levels to fluctuate, such as amount of insulin taken, the amount of food ingested, the type of food ingested, and the amount one exercises. As such, it is preferable for a diabetic to keep records of periodic blood glucose levels to determine proper medical intervention.

Glucose meters measure the amount of glucose present in an individual's blood. To use a glucose meter, the user typically places a small sample of blood on a test strip. A chemical present on the test strip (typically glucose oxidase, dehydrogenase, or hexokinase) then combines with the blood to create a reaction. When the test strip is inserted into the glucose meter, the meter measures the chemical reaction and translates the reading into a score indicating the individual's blood glucose level. The score is displayed or printed.

Among the problems associated with self-monitoring of blood glucose levels in the glucose meters with audio output is the ability to associate a given score from a glucose meter with the diet and activities (and remainder of individual's regimen). It has been left to an individual to manually record data such as when they ate, when they exercised, how long they exercised, and the like, typically after the event. The physician then must attempt to correlate such activity and the individual's blood glucose level. US application No. 2008/0161667 discloses glucose meters which incorporate a recording means and speech synthesizer for audio output of recorded information. However, such glucose meters are expensive and difficult to handle for a visually impaired diabetic.

Known in the art are glucose meters which include audio output to aid a user with vision loss in self-monitoring blood glucose levels. One such device is commercially available from Roche diagnostics under the trade name “Accu-check Voicemate.” Also commercially available are speech synthesizers which attach to glucose meters. Examples of such commercially available voice synthesizer are the “Voice-Touch” speech synthesizers produced by Myna Corporation for use with Lifescan glucose meters and “Digi-voice” speech synthesizers produced by Science Products also for use with certain Lifescan glucose meters. These speech synthesizers are not interchangeable, i.e., they cannot be used interchangeably with various glucose monitors. Therefore, unknown are the speech modules which incorporate one or more of a recording means, a synthesizer, a voice processing means for audio output of recorded information (or virtually concordant recordings, stored for later viewing), and further can be interchangeably used with more than one glucose monitors. Thus it is a further object of the present invention to provide a speech module which incorporates a recording means to speak instructions, test results, and recorded information to the user aloud.

Also unknown are speech synthesizers used with blood glucose meters that have a replaceable memory cartridge which can store the results and be taken out for connection to a personal computer to download the data stored on the cartridge.

It also has been recognized by the inventors that cell phones are ubiquitous, including amongst the visually impaired, and the concept of a universal speech module can be implemented with an application downloaded on a smart phone. In this manner, the smart phone functions as the separate speech module and merely can be implemented as a software application.

### SUMMARY

In one general aspect, there is provided a speech module for attaching to a medical device and providing a clear and accurate auditory component to the device. The speech module includes (a) an audible signal generator; (b) a recording means for recording data virtually simultaneously with daily activities stored for later viewing; (c) a port or a connector for interchangeably connecting the module to the medical device; and (d) a control unit comprising an on/off switch to start or stop the module operation, a switch to control the volume, and a button to repeat the message emitted from the speaker.

Embodiments of the module may include one or more of the following features. For example, the audible signal generator may include a voice processing means and a synthesizer. The voice processing means may be a speaker. The recording means may records information input by the patient for analysis. The voice processing means may speak instructions, test results and recorded information to the user aloud. The voice processing means may repeat the instructions, test results and recorded information to the user aloud by pressing the repeat button. The synthesizer voice can be either male or female. The synthesizer voice can be translated into one or more languages.

The volume of the voice synthesizer may be increased, reduced or completed silenced. The instructions and/or results may be viewed directly on the display screen.

The module may further include a visual display. The test results and recorded information may be provided to the user aloud as well as displayed on the visual display. The visual display may be a display screen. The display screen may function independently of the voice processor/synthesizer so as to allow the user to have instructions and/or results presented via the display screen and/or voice synthesizer.

The module may further include a built-in microphone for recording. The recorded data may include data acquisition via voice processing. The data may be acquired concurrently with the glucose level then tested. The data may include dietary consumption, exercise, medical information (size, BMI, other conditions, other medications, etc.), comments and instructions.

The voice recording may be recorded in a way or other format.

The medical device may be a glucose monitor, blood pressure monitor, or a thermometer.

The speech module may be connected to the medical device by a connecting means. The connecting means may be a connecting wire, a blue tooth and/or Infra-red radiation.

The module may include a port that is connected to a second port in the medical device through a connecting wire. The module may have the on/off switch and volume control switch being the same.

The module may further include a memory chip for acquiring and storing data. The chip may further include counts that reduce by one unit for every usage of the medical device.

The attached medical device may require charging after fixed number of usages.

The may be compatible with more than one medical device.

In another general aspect there is provided a method for operating an integrated speech module configured to provide auditory component to a medical device, the method comprising attaching the integrated speech module, including a voice processing means, to a medical device, receiving and processing the signal in the voice processing means, converting the signal into audio signal for the speaker and transmitting the signal to the speaker as audible instructions, test results and recorded information to the user, the user pressing the repeat button to repeat the measurement emitted from the speaker.

In another general aspect there is provided a method to provide audible output of a piece of information by an audible signal generator. The signal generator is arranged in a speech module configured to attach to an analysis system for analyzing fluid sample, wherein analysis results are generated and processed by the analysis system, and where the on/off switch, in the attached speech module, when in on position, actuates the audible signal generator. The signal generator audibly outputs the piece of information.

In another embodiment, there is provided a speech module containing an audio device for attaching to a medical device, wherein the audio device relates to an integrated speech module comprising a smart phone for attaching to a medical device for providing a clear and accurate audio component to the device. The smart phone includes an “App” for recording and storing data virtually simultaneously with daily activities stored for later viewing, a port or a connector for interchangeably connecting the module to the medical device, a control unit comprising an on/off switch to start or stop the module operation, a switch to control the volume, and a repeat button to repeat the message emitted from the speaker.

In another general aspect there is provided a method to provide audible out put through a smart phone wherein the smart phone reads the glucose reading from the glucometer. The method comprises downloading an “App” on the smart phone to convert the digital readout on the standard glucometer to an audio readout that is spoken “through the smart phone”, connecting the glucometer to the smart phone using a cord or a bluetooth connection to power on the “App”, opening the “App” and connecting to the glucometer, using the glucometer in the traditional way to generate blood glucose data, receiving the data on the smart phone, and the smart phone speaks instructions, test results, and recorded information to the user aloud.

In another general aspect there is provided a software application for providing a speech module on a smart phone for communicating with a medical device to provide a clear and accurate auditory output of the medical device on the smart phone. The application includes:

(a) code for turning on the software application on the smart phone;

(b) code for communicating with the medical device to receive data from the medical device;

(c) code for recording and storing the data on the medical device;

(d) code for providing as an auditory output from the smart phone the data received from the medical device;

(e) code for permitting an auditory input to the smart phone through a microphone on the smart phone.

Embodiments of the software application may include one or more of the functions described above or discussed below. For example, the software may be configured to convert the digital readout on the medical device to an audio output from the smart phone. The software may be programmed for the smart phone to received data from the medical device via blue tooth connection, IR, or a connecting wire. The software may be programmed to provide a user the ability to e-mail, download and/or view the data received from the medical device or data input by a user. The software may be configured to include counts that reduce by one unit for every usage of the medical device transmitted to the smart phone.

Embodiments may include one or more of the features discloses herein or listed above.

The details of various embodiments of the invention are set forth in the accompanying drawings and the description below. Other features and advantages of the invention will be apparent from the description, the drawings, and the claims.

### BRIEF DESCRIPTION OF THE DRAWINGS

FIG. 1 is a flow chart showing steps for generating an audible signal from the speech module of an audio device connected to a medical device.

FIG. 2 is an illustration of one embodiment of a speech module for providing audible signals from a medical device.

FIG. 3 is a block diagram of the hardware components of a second embodiment of an audio device for a medical device.

FIG. 4 is a block diagram of the software logic of the second embodiment of an audio device for a medical device.

FIG. 5 is a block diagram of the filtering circuitry for the filtering the signal between the microprocessor and the speaker.

FIG. 6 is a flow chart illustrating the audio streaming flow diagram.

FIG. 7 is a flow chart illustrating the expiration monitoring flow diagram.

FIG. 8 is a flow chart illustrating the user interface flow diagram.

FIG. 9 is a circuit diagram illustrating the power on circuit diagram.

FIG. 10 is a block diagram of the components of an embodiment relying on a mobile phone as the speech module interacting with the glucometer.

FIG. 11 is a flow chart showing steps for generating an audible signal from the speech module of a smart phone connected to a medical device.

### DETAILED DESCRIPTION

Auditory output from an analysis system for analyzing a sample needs to meet particular demands on its operability. A user's health may depend on the results of the analysis being output correctly in clear, audible form, especially if the user is vision impaired. For example, a measured blood glucose value is used by to determine how much insulin should be administered to a diabetic.

The auditory signal generator is designed to avoid providing unclear audio output by using an audio signal generator in a speech module attached to the analysis system. The audio device achieves this by providing a robust integrated speech module that is configured to attach to various glucose meters to provide accurate and clear audio output of the analysis.

In one general aspect, the audio device relates to an integrated speech module for attaching to a medical device for providing a clear and accurate audio component to the device. The speech module includes an audio signal generator, a recording means for recording data simultaneously with daily activities stored for later viewing, a port or a connector for interchangeably connecting the module to the medical device, and a control unit comprising an on/off switch to start or stop the module operation, a switch to control the volume, and a button to repeat the message emitted from the speaker. The recording means allows the user to record their own voice as a result handling and instruction medium.

The device can further include an interactive speech module that includes an input means for use by the patient to input information relevant to the blood glucose measurements, such as when they ate, what they ate, when they exercised, how long they exercised, and the like. The information is typically input after the event, thereby eliminating the need to maintain a record of daily activities to understand the correlation with such activity and the individual's blood glucose level.

The voice module may be provided with a microphone that allows the user to record information relating to their diet, amount of exercise, level of stress or illness, and other circumstances concurrently with the user's periodic testing and recording of their blood glucose level. This allows the user and/or healthcare provider so as to flag and store the data with the patient's activity data such that the patient can have immediate access and render modifications and monitoring as necessary. The information may be recorded via a recording device, e.g., a microphone, incorporated directly into the speech module. The voice recordings can be recorded in way or other auditory format.

The speech module may be provided which incorporates a recorder, an audible signal generator comprising a voice processor, and a synthesizer, to both record spoken data and speak instructions to the user aloud. The synthesizer voice can be either male or female, and optionally may be translated into a multiplicity of languages. The volume of the voice synthesizer may be increased or reduced depending on the user's preference. The instructions and/or results may be viewed directly on an optional display screen.

The voice processing means may repeat the instructions, test results and recorded information to the user aloud by pressing the repeat button.

The speech module may be provided which incorporates a display screen to aid the visually impaired or for the people who are assisting them. The display screen functions independently of the voice processor and synthesizer so as to allow the user to have the instructions and/or results presented via the display screen and/or the voice synthesizer.

The speech module includes a connection, such as a port, cable or connecting wire for connecting to the audio device to a medical device. In another embodiment, both the medical device and the speech module include a port and are connected by a connecting wire. In still another embodiment, the speech module can be connected to the medical device through blue tooth or through an infrared technique. The control unit in the speech module includes an on/off switch, a switch to control volume and a repeat button configured to actuate voice processing means to repeat the instructions, test results and recorded information to the user aloud by pressing the repeat button.

The audio device includes a memory processor for acquiring and storing data. The memory processor is configured to include a maximum number of counts which go down by one unit after each usage of the attached medical device. The maximum number of counts in the chip may be forty five such that at the end of forty five usages the count number reduces to zero. Of course, any number of usages may be programmed such that the device can be used for one month. The count number is either visually displayed on the visual screen, or spoken aloud by the voice processor present in the speech module. In another embodiment, the count number is both displayed on the visual screen and spoken aloud by the voice processor. In another embodiment, the speech module needs charging when the count number reaches zero.

The speech module may be interchangeably handled with more than one medical device, such as a glucose monitor, a blood pressure monitor, or a thermometer.

In another embodiment, the audio device relates to an integrated speech module in the form of a smart phone for attaching to a medical device for providing a clear and accurate audio component to the device. The smart phone includes an “App” for recording and storing data virtually simultaneously with daily activities stored for later viewing, a port or a connector for interchangeably connecting the smart phone to the medical device, a control unit comprising an on/off switch to start or stop the module operation, a switch to control the volume, and a repeat button to repeat the message emitted from the speaker. The on/off switch, the volume control switch and repeat button can be in the form of an interactive screen on the smart phone in which the user presses certain areas of the screen to cause the volume to increase or decrease, repeat, etc. Alternatively, these functions can be controlled by standard buttons on a smart phone, e.g., volume button, etc.

When the speech module is implemented in the form a mobile phone, the Patient downloads the “App” from an iPhone store, Android store or the like, onto the smart phone. The purpose of the “App” is to convert the digital readout of the glucose meter into an output that is output through the speaker of the smart phone and auditory output. The Patient may have an option of purchasing the “App” through an App store for a fixed amount per month, a single fee, or by authorizing the glucometer provider to automatically invoice the insurance provider/Medicaid for the fee associated with the App. The smart phone is connected to the medical device via any one of a number of connections, e.g., blue tooth connection or USB cable, or other connecting wire. The smart phone speaks/emits instructions, test results and recorded information to the user aloud. The Patient may repeat the instructions, test results and recorded information by pressing the repeat button.

The smart phone may further include a memory chip for acquiring and storing the data from the medical device. In one implementation, the memory chip can store up to 200 readings. In other implementations, the memory chip may store significantly more readings. The data can be e-mailed, downloaded and/or viewed by the patient and/or patient's doctor. The recording function allows the user to record their own voice in the memory to annotate the data as desired.

Also provided is a method for operating the speech module configured to provide an audio component to a medical device through the smart phone with the smart phone reading the glucose reading from the glucometer. The method includes downloading an “App” on the smart phone to convert the digital readout on the standard glucometer to an audio readout that is spoken “through the smart phone”, connecting the glucometer to the smart phone using a cable, cord or blue tooth connection to power on the “App”, opening the “App” and connecting to the glucometer by clicking “Connect to Glucometer”, using glucometer in the traditional way to generate blood glucose data, receiving the data on the smart phone, and the smart phone speaks instructions, test results, and recorded information to the user aloud. In another embodiment, the patient can connect to the glucometer by “speaking to the phone and saying “connect.”

In another embodiment, a method is provided for operating a speech module configured to provide an audio component to a medical device. The method includes attaching the speech module to a medical device, receiving and processing the signal in the voice processing component of the speech module, converting the signal into an audio signal for the speaker and transmitting the signal to the speaker as audio instructions, test results and recorded information to the user, and optionally pressing the repeat button to repeat the measurement emitted from the speaker.

In another embodiment, a method is provided for audio output of a piece of information by an audio signal generator. The signal generator is arranged in the speech module and is configured to attach to an analysis system for analyzing fluid sample. The analytical results are generated and processed by the analysis system. The on/off switch in the attached speech module when in on position actuates the audio signal generator. The signal generator provides audio output of the information.

At the heart of the audio device is a memory processor configured for receiving the data from the attached medical device. The memory processor is further configured to store and transfer the data to the audio signal generator. The audio signal generator includes a voice processor and a synthesizer. The synthesizer produces human speech and the voice processor speaks instructions to the user aloud. The synthesizer's voice can be either male or female, and may be translated into multiplicity of languages. The memory processor receives data from the medical device, stores the data, and transfers the data to the audio signal generator. The synthesizer in the audio signal generator is actuated when the on/off switch in the control device is in the on position. The synthesizer synthesizes the speech and the voice processor/speaker emits the instructions aloud.

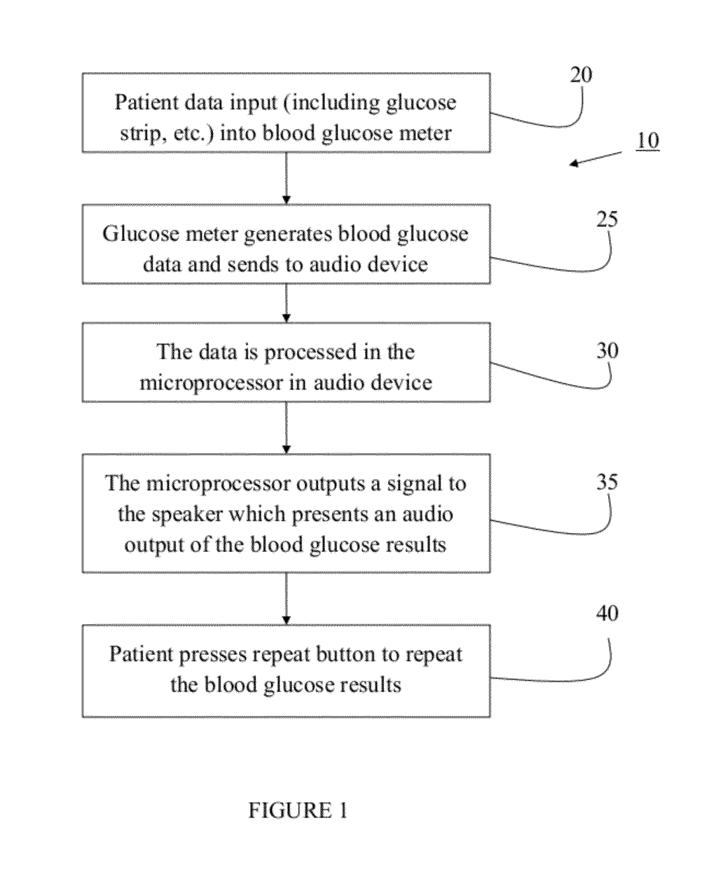

FIG. 1 is a flow chart that illustrates the steps for generating an audio signal from the speech module. The patient enters data (step 20), e.g., glucose strips placed in glucometer. After the input of patient data the glucose meter generates blood glucose data and sends data to the audio device (step 25). The data is processed in the microprocessor in the audio device (step 30). The microprocessor outputs a signal to the speaker which presents an audio output of the blood glucose results (step 35). The patient presses repeat button to repeat the blood glucose results (step 40).

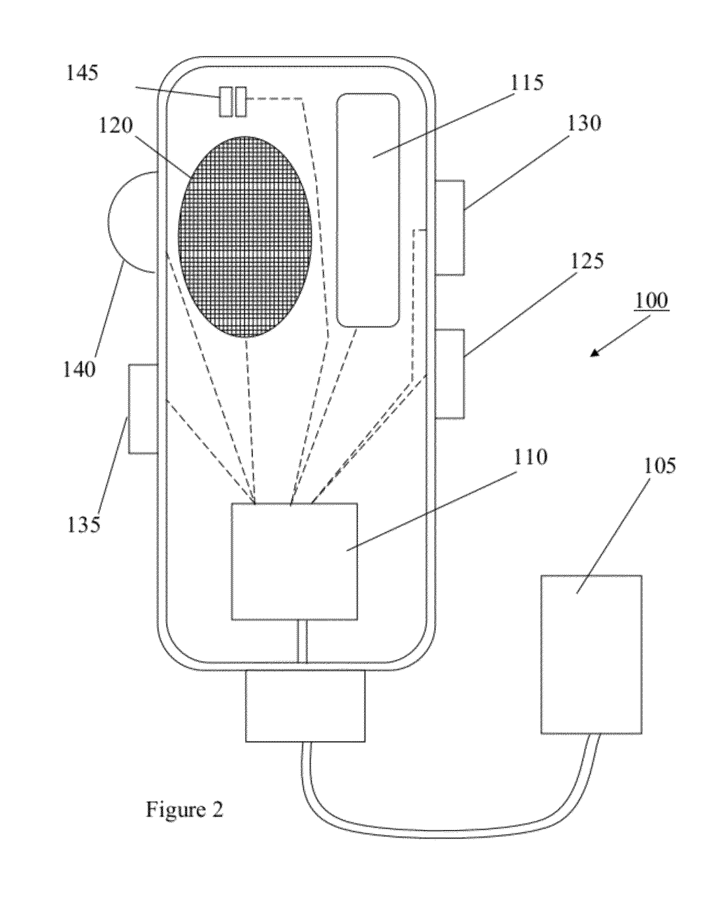

Referring to FIG. 2, an auditory device 100 is configured to be physically and electronically connected to a blood glucose meter or other data measurement device, e.g., temperature measurement device, blood pressure measurement device, etc. that includes a USB or serial output port. The blood glucose monitor will operate in the typical manner of a blood glucose monitor, e.g., blood is placed on a test strip that is analyzed by the meter, data is reported and optionally stored. The monitor also will include an output port that can be used to transmit data to a medical facility, physician's office, computer, etc. Although typically a USB or serial port is used, other port configurations are suitable for use.

The auditory device 100 includes a connector 105 that is connectable to the USB, serial or other port on the blood glucose monitor. The connector may extend directly from the device 100 or may be connected to the device 100 through use of a short cable. Additional cables or other connecting means may then connect to the memory processor 110.

The memory processor 110 may be of a variety of configurations known in the art and include a variety of functions, such as memory, storage, processing, programming, etc. The processor may be configured to include software for processing sound (input and output), providing signals for an LED or LCD display, storing results provided by the blood glucose monitor, etc. The processor provides electronic signals to other components in the device 100, including an LED/LCD display 115, a speaker 120, and a microphone 145. The microprocessor receives electronic signals from switches 125, 130, 135 and a volume dial 140. The switch 125 may be an on/off switch; the switch 130 may be a multifunction switch for providing options to the user, e.g., recording information received from the blood glucose monitor; and the switch 135 may be a switch used to indicate an affirmative or make a selection. For example, the user may press switch 125 to activate the device and then use switch 130 to scroll through a series of options presented to the user, such as “present results from meter,” “present stored results,” “input voice recording,” “download stored information,” and “recharge account.” By pressing the switch 130, each of the options is presented sequentially to the user as an audible output through the speaker 120 and/or an output on the display 115. By pressing the switch 135 after an option is presented, that option will be selected. For example, after the user presses the switch 130 and is presented with the option to “present results from meter,” the user presses the switch 135 to select that option. By pressing switch 135, the user will hear and see the blood glucose readings from the blood glucose monitor.

The device 100 also includes the ability to voice annotate the blood glucose results, such as with a recording by the user of food intake, exercise levels and amount of exercise during the period associated with a particular blood glucose measurement. This information then is stored in the device and presented to the user's physician. For example, the user may use the switch 130 to scroll the list of options and select to hear the results from the blood glucose meter, as previously described. The user may then decide to annotate that measurement with food and exercise information by using the switch 135 to scroll through the options until presented with an option to input a voice recording. The user then presses the switch 135 to select the voice recording option, and is given instructions to press switch 135 again to start recording and then press switch 135 once again to finish recording. The operation may be accompanied by voice prompts when starting and stopping recording. The user therefore will press switch 130 until provided with the option of inputting voice recording, at which time the user presses switch 135 to select that option. The user will then be presented with a voice prompt that may be as follows:
Press the button once again to initiate voice recording. You will hear an audible tone when the voice recording has been activated. When you are finished voice recording, press the button again. You will hear the following prompt “Recording stopped” to inform you that the recording has ceased.

The user presses button 135 and will hear an audible tone indicating that voice recording has started. The user annotates the blood glucose measurement with food and exercise information and presses the button 135 once again, at which time the user will hear an audible “Recording Stopped” affirming that the recording has ended.

The user then may decide to select the option of reviewing the stored results by selecting the “present stored results” option. The user presses the button 135 to scroll through the options until the “present stored results” option is prompted. The user then presses the button 135 to select that option. The user then will hear the most recent blood glucose reading and any voice annotations associated with the blood glucose reading.

As an option for the presentation of stored results, the device 100 can be programmed so that the user can hear all of the stored results. In this option, after hearing the first stored result the device will prompt the user by stating “To hear the prior stored result, press the button again,” at which time the prior recorded result with annotation will be reported. The user can continue in this manner until all of the stored results and annotations have been reported. This feature can be advantageous if the user wishes to scroll through the results with a physician or medical caregiver without downloading the information onto a computer.

With the annotated blood glucose measurements stored on the device 100, the user can download the stored contents at a physician's office so that the physician can analyze the results and add the information to the patient's medical records. To download the results stored on the device 100, the user or physician plugs the connector 105 into a USB, Serial or other input port in a computer system and from the computer searches the memory in the device. The device can be configured such that the results are stored in a format and named in a manner that permits simple and quick access and downloading. As part of the downloading process, the user or physician downloading the data may be given the option to delete the downloaded data to free up memory in the device.

Alternatively, the data can be downloaded onto a flash drive or other storage device using the “download stored information” function. The information then will be transferred and stored on that storage device. For example, a flash drive can be connected to the USB connector 105, the “download stored information” function activated and the blood glucose result and any annotations will be downloaded onto the flash drive. The user then can provide that flash drive to a physician or medical caregiver to view the information stored on the flash drive.

In one embodiment, the device 100 can be implemented such that it is provided to the user free of charge but the users pays a fee based on usage. Such a model is similar to a cell phone that can be credited to have additional minutes and thereby the fees are associated with the amount of usage of the device rather than merely the possession of the device. For example, the device may be provided with a credit of 45 blood glucose measurements and then it must be “charged” or credited with additional credits to be used for more blood glucose measurements. In this embodiment the device may be credited with numbers of measurements by a number of methods. For example, supplies of disposables for diabetics are typically provided to users on a monthly basis. Along with these supplies the user can be provided an inexpensive USB compatible memory device that connects to the USB connector 105. The memory device is programmed with a code that can be read by the device 100 and additional credits transferred from the memory device to the device.

The credits are transferred from the memory device to the device 100 by selection of the “recharge account” function. As explained above, the user scrolls through the selection of functions 135 until the recharge account function is prompted. Upon pressing button 135 the user will be prompted to recharge the account by inserting a memory device into the USB connector 105. The user will be given step-by-step instruction for recharging the account. For example, upon inserting the memory device into the connector 105, the user will be prompted to press button 135 to start the transfer of data and the wait until the device gives an audible indication that the data has been transferred, such as by an indication that “data has been transferred successfully, remove memory device.”

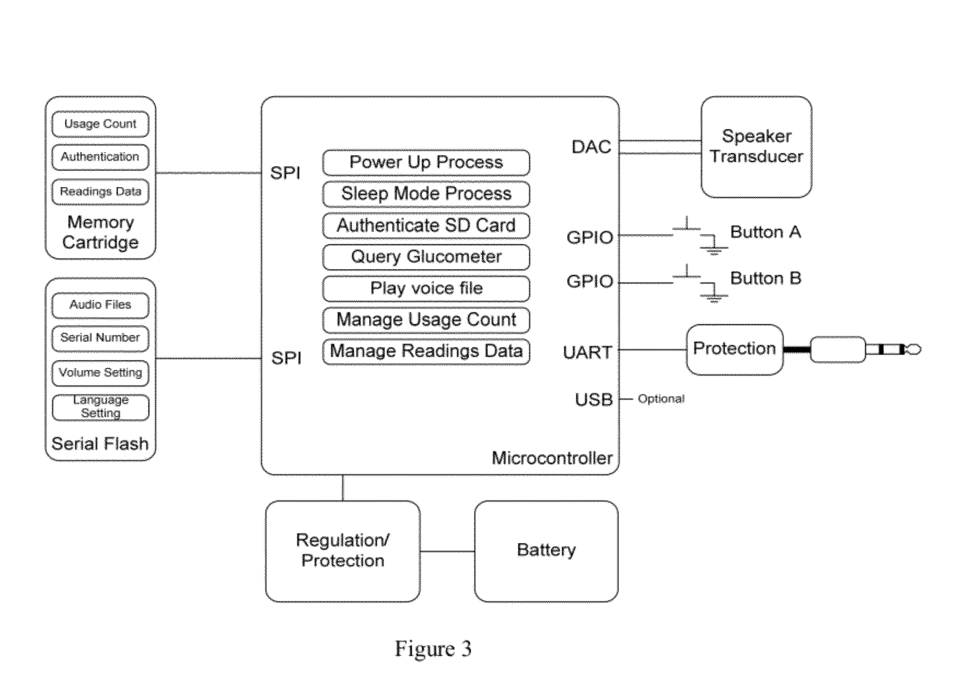

Although a general overview of one embodiment of the auditory device has been described above with reference to FIGS. 1 and 2, more specific details are provided for another embodiment of the auditory device in FIGS. 3-9. In general, the auditory device, or talking glucometer device, is an accessory to a standard glucometer. The accessory provides two main functions: it reads aloud the final glucose measurement to enable blind users to determine their blood glucose levels. It also records a maximum amount of measurements on a plug-in memory cartridge. For example, the device can record one months of blood glucose levels on the memory cartridge and then after one month, the cartridge is returned to the source.

Additional general requirements of the device include the following: (a) the device must read the most recent glucose test result from the meter and announce it over a speaker along with the date and time stamp; (b) the device must easily mate with the serial barrel connection at the base of the blood glucose meter; (c) pressing a button on the device must wake up the meter and initiate communications between the glucose meter and device; (d) the device shall provide electrostatic discharge (ESD) protection on the serial connection (e.g., of at least 12 kV); and (e) the hardware shall be able to support USB connectivity though there need not be any software support.

Physically, the inventors have determined that the device should be longer than wide and have a thinness that is optimized over its length and width. As optional maximum dimensions, the maximum length should be approximately 4.5 inches and the maximum width should be about 2 inches in order to fit within a pouch pocket. The device also should be capable of fitting within a glucose meter pouch.

The device should be tethered to a glucometer via an electronic cable. Although, the device is tethered with a cable, optionally it can use IR or Bluetooth to transmit data. The circuit board of the device therefore may have room or capability for using IR or Bluetooth. The device is designed to work with a large variety of blood glucose meters, such as the LifeScan OneTouch Ultra2 meter, although other embodiments of the device may be configured to work with only a single meter, thereby reducing the software, hardware and updating requirements that would be required for the ability to use the device interchangeably with multiple meters. If configured to work with any blood glucose meter, the device can have sufficient software to recognize the meter being used and communicate with the meter, as is well known to one of skill in the art. Such abilities are well known, for example, in the field of printers and computer peripherals which must work with almost any computer on the market.

Because a primary purpose of the device is high quality sound playback to the user, a high quality speaker is used. The volume control for the audio device can be as simple a single button that allows the audio to be played over a speaker in one of three volumes: high, medium, and low. Alternatively, the device can include a dial type controller that allows continuous adjustment of the volume.

Another important aspect of the device is the replaceable memory cartridge. The accessory house a replaceable memory cartridge that stores the blood glucose measurements for an extended period of time and allows those measurements to be provided to a physician's office for downloading and review. Because the memory cartridges are reused by different patients, the cartridges are sterilizable via ethylene oxide or an autoclave. The cartridges are configured such that during the sterilization process, data is not lost. Amongst the data stored on the cartridge is the battery voltage measured each time the glucose test results are written into the device, as well as at least one month's worth of glucose test results. Of course, the amount of data stored can be varied by using cartridges with greater memory capacity or configuring the software to permit a particular number of measurements or unlimited measurements of a particular length of time.

If using a replaceable memory cartridge, the user or a healthcare worker can connect the cartridge to a computer, such as a personal computer or laptop, and read the data off of the memory cartridge using an appropriate software application.

Upon obtaining a new memory cartridge, the user installs the cartridge into the device. Once the device is turned on, the most recent test result is transferred to the cartridge and becomes the first reading on the cartridge. Older test results stored in memory are ignored. As explained above, the cartridge will only allow one month worth of results to be stored although other periods can be used instead as desired. This period is measured from the oldest result on the cartridge to the newest result on the meter. If this time span is greater than one month, then new glucose results will not be played over the speaker or stored on the cartridge. The user must return the memory cartridge to a healthcare worker or other intermediary and obtain a new memory cartridge. A benefit of this requirement is that a healthcare giver will have an opportunity to look over the last month's blood glucose values and look for trends or healthcare concerns. If the cartridge is not returned to the healthcare worker on a frequent basis, the patient may not receive the benefit of a skill healthcare worker spotting health issues that should be addressed before irreversible damage occurs.

As another feature of the operation of the device, when there are existing test results on the memory cartridge and the device is turned on, all results newer than the most recent result on the cartridge will be transferred to the cartridge. This is intended to cover the case where the user fails to use the device with the blood glucose meter for several intermediate tests. This permits the user to capture all data even if the audio device was not used with the blood glucose meter for a number of tests, e.g., the patient forgot to bring the audio device on a weekend trip.

As part of the tracking system of the device and cartridges, the device must be able to match a unique ID on the cartridge to a unique ID within the device. Only if these unique IDs match will the device consider the cartridge to be authenticated. For related reasons, the device will operate only with preformatted memory cartridges. The PC used by a healthcare worker is primarily or only used for reading and refurbishing the cartridge.

In one embodiment, the audio device is battery powered using replaceable batteries or batteries that can be charged by use of a USB connect, plug or any conventional power supply means known to one of skill in the art. The battery life of the device should be at least 1000 test results before it must be recharged or replaced. The inventors have determined that in one aspect the battery life is not unduly impacted if the buttons are pressed for excessive times such as when an object in the storage case rests against the accessory. Software and/or hardware is used in the device to react to such occurrences. Further, the extend the battery life, the device draws minimal current from the battery when turned off.

The device has a number of user interfaces and audio prompts. For the user interfaces, the device is provided with two buttons, A and B, for user feedback, with pressing either button turning the device on. Each button can be configured for a number of purposes depending upon how the button is activated. A short press of button A will announce the results and date/timestamp of the last glucose test; a long press of button A will announce the remaining time on the cartridge; and subsequent presses of button A will adjust the language setting. A press of button B will increment the volume. In one embodiment, a button press is defined as the user pressing a button for at least 250 milliseconds and less than 2 seconds, and a long button press is defined as the user pressing a button for at least 2 seconds.

To maximize battery life, after all actions are complete and a short timeout expires, the accessory will turn itself off.

During use of the device, it is anticipated that buttons will be accidently pressed by the user. To prevent these accidental button presses, all button presses occurring while the device is already performing some action will be ignored. Therefore if the results are being reported, accidentally or intentionally pressing button A or B will not interrupt the reading.

Because it is anticipated that a device will be used by a single patient, it is expected that the user will set the volume to a preferred loudness. Therefore, upon setting the volume, the volume will be stored persistently and each time the device is used, the volume will be at that set volume. Changing the volume, of course, will reset the volume to a new level. Because the volume is associated with a particular user, the volume setting is independent of the memory cartridge but instead is dependent on the device. As one additional feature, the device can be configured such that one or both of the buttons is placed on a tether cable.

As mentioned above, the device also has audio prompts, which of course are important when targeting a device to those with limited visual abilities. To accommodate this population, the audio output supports both English and Spanish, although other languages may be implemented as desired. The audio playback of the test results will include at least the date, time, and glucose reading. Several audio announcements also will be played depending upon the circumstance. For example, “Downloading” is played when the user presses the button to hear the results of a test; “Low Battery” is played prior to “Downloading” if the battery has less than 10% life remaining; and “No test result in last 2 hours” is played if the glucometer has not performed a test in the previous two hours.

Other audio prompts are directed to the connection or communication status between the device and blood glucometer: “Connection Error” is played if the accessory is unable to communicate with the meter; “Cartridge Error” is played at power up if the memory cartridge could not be authenticated or communications to the memory cartridge could not be established.

Other audio prompts relate to the amount of reading remaining on the cartridge: “Cartridge Expired” is played at power up if the memory cartridge has expired; and the number of days remaining on the cartridge is played when the accessory is powered up through a long press of the button.

“Test Error” is played when the glucometer detects a checksum within its internal memory. This is the only error which the glucometer indicates. “Volume Low”, “Volume Medium”, or “Volume High” is played at the new volume level when the volume is changed.

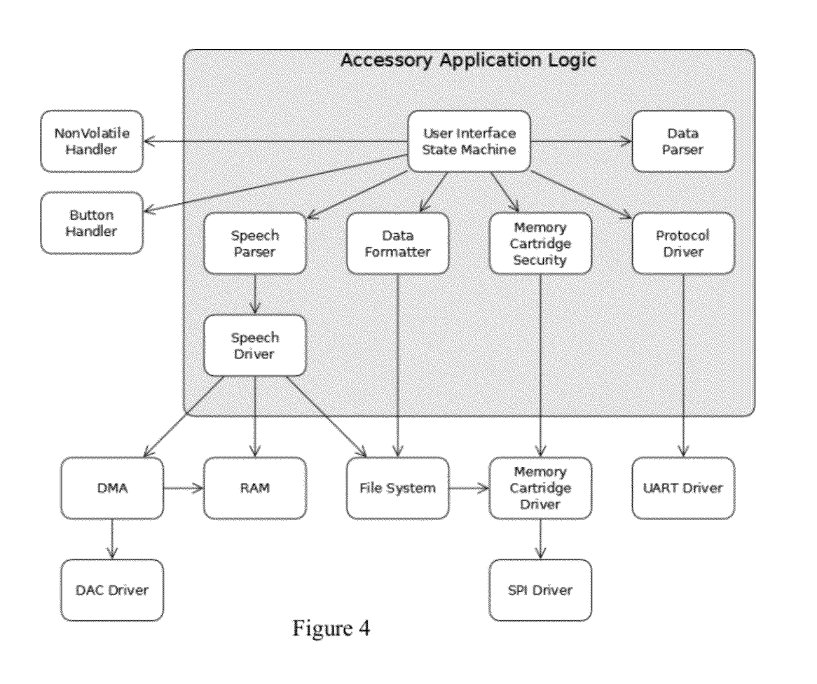

Referring to FIG. 3, the audio device is illustrated in block diagram form that depicts the various hardware and software components. Referring also to FIG. 4, the software and hardware application logic is illustrated. In a most simple implementation, the memory cartridge contains only the physical memory device. This implementation provides a simple electrical interface to the memory cartridge. As is known in the art, there are a number of memory devices that are readily available with mating sockets that can be used with the device.

The memory cartridge can also contain the battery that will supply power to the audio device. This configuration eliminates the need for the user to change batteries separately from changing out the memory cartridge. This simplicity is advantageous for a patient with impaired vision. As a comparable battery for the audio device, the battery supplied with the commercially available OneTouch Ultra2 blood glucose meter is capable of performing 1000 tests. Because a typical user will expect the same basic battery life from the audio device's battery, configuring the battery with the memory cartridge eliminates this expectation and thereby permits use of a much smaller battery. This advantageously reduced cost and size of the audio device.

In some implementations, the electrical interface to the memory cartridge would need to include power connections in addition to the signaling connections to the memory device. This requirement is expected to create an obstacle to aftermarket and overseas manufacturers who might produce subpar cartridges that could damage the reputation of the device as well as being used to circumvent a one month period, or other period, associated with use of the memory cartridge before it must be recharged.

In another implementation, the memory cartridge can contain all or most of the electronics within the audio device. This limits the audio device to being a simple plastic shell with a few electrical connections and optionally the audio speaker. This approach is advantageous because it greatly reduces the number of electrical connections between the audio device and the memory cartridge mounted within the device, leading to improved reliability. While this implementation offers certain advantages, the cost to manufacture the memory cartridge will be increased. At the user level, the audio device would no longer be able to maintain user settings such as the volume because it is not necessarily the case, or even very unlikely, that the same memory cartridge will be returned to the same user each time.

As explained above, a requirement of the memory cartridge is that it be sterilizable. Placing additional electronics or batteries within the memory cartridge increases the difficulty of making the cartridge sterilizable. Companies such as DataKey make a variety of removable memory devices, including the GammaSafe memory token which can be sterilized a couple of times by radiation sterilization.

Of course, steam and ethylene oxide sterilization also can be used to sterilize the memory cartridge. If the device is limited to sterilization techniques of ethylene oxide and autoclaving there are more viable choices for the memory cartridge.

As noted above, the device can operate in one or more languages. The language files can be stored on the memory cartridge although doing so significantly increases the cost of the memory cartridge and requires additional memory.

The audio playback functionality of the accessory can be implemented in a number of ways which vary greatly in size, power consumption, cost, and complexity. At the highest end of the spectrum are text-to-speech chips. These chipsets are capable of converting written text to a series of phonetics. Often these phonetics are then passed to a second chip such as the Magnevation SpeakJet. Advantageously, these types of chipsets provide a great deal of functionality, but disadvantageously, these chipsets can be expensive, large and have increased power consumption. For some uses these chipsets are preferred.

Audio playback chips exist in the middle of the spectrum. These chips contain built-in audio amplifiers and built-in filtering, may play PCM audio streamed from the microprocessor or may play files stored on an external serial flash. Advantageously, these chips provide high quality audio in a relatively compact size. One example of such a chip in this middle tier is the Keterex KX1400.

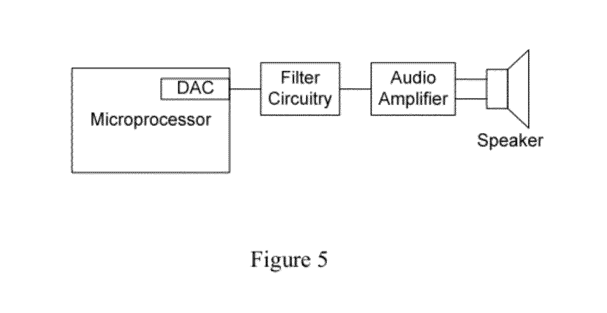

In another implementation, the audio device uses a digital-to-analog converter on the microprocessor to drive an audio amplifier. This configuration provides a low cost and small device. As known in the art, with this configuration there will likely be a need for filtering circuitry between the digital-to-analog converter and the audio amplifier to smooth edges between samples sent to the digital to analog converter, thus reducing the noise. This implementation uses the digital-to-analog converter of the microprocessor as the audio source. The audio topology of this configuration is illustrated in FIG. 5. Although this configuration may be preferred in some applications, the other playback chips described above may be more preferred in other applications.

The audio data rate associated with the device will be optimized for quality playback. To meet the requirement of a 3,000 Hz audio bandwidth, the audio must be sampled at a rate no less than 6,000 Hz. A sampling rate of 8,000 Hz matches that of many common recording formats and provides margin for meeting the required bandwidth without stressing the system's capabilities. As such, an 8,000 Hz sampling rate may be used to obtain suitable, high quality results.

The audio data rate is also affected by the size (bit width) of the sampled data. For intelligible speech, 8 bits per sample is often considered to be a minimum. Ten bit sampling will noticeably improve the audio quality, while 12 or 16 bit samples will provide a larger dynamic range for volume adjustment. Because larger samples increase the bit rate and because the DACs of many general-purpose microprocessors are limited to 10 bits, one suitable sample size for the audio device is a 10 bit sample. A 10 bit sample will provide good audio quality with an acceptable dynamic range.

To improve the range of the volume adjustment using a 10 bit DAC, it is possible to directly adjust the audio amplifier using GPIO lines. With a sample size of 10 bits and a rate of 8,000 Hz, the resulting data rate is 80 kbit/sec. Because the audio output for the audio device is limited to a set of short phrases and numbers, as explained above, and serial transfer bandwidth is unlikely to be an issue, the audio can be stored in an uncompressed PCM format to reduce computation time in the processor and optimize overall audio throughput.

It is estimated that the audio device will need a vocabulary of between 60-70 words and phrases. These include the names of the months, cardinal and ordinal numbers, and less than a dozen specific phrases. Because of this simple, fixed vocabulary set, a full-blown text-to-speech engine is unnecessary, although optionally can be used if desired. To eliminate the cost and complexity of a text-to-speech engine, a pre-recorded set of words and phrases can be used instead.

In practice, the audio device can function by stringing together individual words and phrases under software control to generate the devices full auditory repertoire. The only disadvantage to this methodology is that the output might sound slightly stilted, similar to automated phone response systems used for customer service. However, because the output represents simple bits of information (e.g., dates, times, and blood sugar levels) rather that being of a conversational format, it is unlikely to be bothersome or even noticeable to most users.

In determining the amount of memory needed for the audio associated with the device, the inventors have determined that approximately 1800 kB are needed, as follows. Assuming an average length of 0.8 seconds per word, the average size of one sound file is 8000 samples/sec×2 bytes/sample×0.8 sec×number of languages=25.6 kB. For a vocabulary of 70 words, the total file space requirement is 1792 kB.

Because multiple languages are expected to be used with the audio device, the grammar of different languages must be taken into consideration. Therefore, when concatenating the individual word files into complete phrases, the software takes into account the word order of a particular language. This is accomplished by a separate setting that indicates the grammar of the loaded language. Examples of grammar files for English and Spanish are shown below in Table 1.

TABLE 1
Examples of grammar files

| English | Spanish |
|---|---|
| language = English | language = Spanish |
| date = [month] + [date] + [year] | date = el.wav + [date] + |
| | de.wav + [month] + [year] |
| time = at.wav + [hour] + [minute] + | time = alas.wav + [hour] + |
| [am-pm] | y.wav + [minute] + [am-pm] |

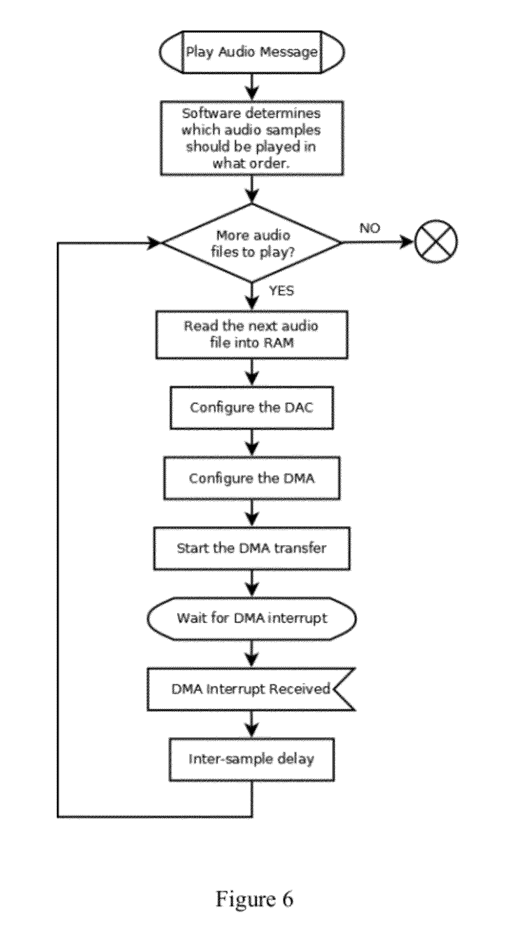

Referring to FIG. 6, an example of an audio streaming flow diagram for the audio device is illustrated. If, for example, an LPC17xx microprocessor is used in the audio device, the microprocessor provides the ability to perform DMA transfers between memory and on-chip peripherals, such as the DAC. Using this mechanism, it is possible to transfer speech data from RAM to the DAC at intervals without the intervention of the CPU. The speed of the transfer is programmable, limited by the settling time of the DAC to a maximum data rate of 1 MHz. The flow diagram in FIG. 6 details the steps for how this operation would work.

A minimum of 16 KB of RAM needs to be reserved for buffering the audio files. If the files are loaded from the serial flash over an SPI interface, a minimum of 2 Mb/s transfer rate can be expected, which is sufficiently fast enough to prevent the DMA from stalling.

It should be noted that because of how the DAC output register must be programmed, each 10 bit sample must first be shifted 6 bits to the left. This step should be done before starting the DMA transfer. To eliminate the extra shifting step at run time, a preferred solution is to pre-shift the data stored in the voice files.

The inventors have determined that the software for the audio device is relatively straightforward. If all audio files are stored off of the processor, and no audio compression is used, it is estimated that the code size will be less than 80 KB. The device then also will require a minimum of 16 KB of RAM for buffering audio files. When the memory required by the program stack, heap, and static variables are also considered, the total RAM usage is estimated to be less than 32 KB. Next, the amount of data generated by the patient must be considered. Individuals with Type 1 diabetes may test their blood sugar level as often as 4-10 times per day. Assuming 60 bytes of data are stored per measurement, this requires about 18,600 bytes, as follows:

60 bytes×10 tests/day×31 days=18,600 bytes

to provide the ability for storing one month of samples/measurements. A 32 KByte memory cartridge will easily hold the required data with some room for expansion should future requirements be added.

In addition to the audio files, several pieces of information have been identified for on-device nonvolatile storage. These include volume, language, and the serial number of the audio device. Although the volume and language could be stored on the memory cartridge, it is not preferred in some implementations as the user would be forced to readjust these every time a new memory cartridge was inserted.

The serial number of the accessory must be stored within the accessory. This is needed so that cartridges can be locked to a specific accessory, as explained above.

The LPC 17XX microprocessor does not contain any processors with enough memory to store all of the voice files. If the LPC 17XX, or other microprocessor with insufficient processor memory to store the voice files, is used a serial flash can be used with the microprocessor to hold the audio files and nonvolatile data.

Table 2 summarizes the memory requirements for the audio device.

TABLE 2
Summary of Memory Requirement for the Audio Device

| Memory Type | Size |
|---|---|
| FLASH | 80 KB |
| RAM | 32 KB |
| Memory | 32 KB |
| Cartridge | |
| External Flash | 2 MB |

The memory cartridge has two features that should be explained in more detail, authentication and expiration. Authentication is required because there is a need to verify that the correct memory cartridge is associated with the correct user. This is required to cover the case where multiple audio devices are used within the same household. There are several ways to accomplish this. First, the memory cartridge could be associated with the serial number of the glucometer. The other approach is to associate the memory cartridge with a serial number within the audio device. Although either approach is suitable, associating the memory cartridge with the serial number of the audio device provides some advantages. For example, as both the audio device and memory cartridges are likely to be sourced by the same service, this association is more natural. The version of the serial number on the memory cartridge can be encrypted in order to reduce the chance of hacking.

Expiration relates to the requirement that the memory cartridge be used for only a particular period, e.g., one month, two months, three months, etc. As explained above, this provides the ability of the healthcare provider to monitor the blood glucose readings over a shorter period of time than if no time limits were set. This may provide advantageous to the patient if the healthcare worker spots trends that could result in adverse, irreversible damage to the patient. To accomplish this expiration, the audio device can be configured to monitor usage and notify the user of an expired cartridge. For tracking calendar days, the device's microprocessor has a real-time clock (RTC) that counts elapsed time. The RTC gets its starting time from the glucometer, which stamps every test result with the time and date. The glucometer's clock and calendar are typically set by the user. Because the user can alter the calendar time that will be input to the audio device, the user can alter the system. To prevent this from occurring, e.g., to require regular review of the blood glucose measurements by a healthcare worker or to ensure any financial arrangements of the device are maintained, the device should be configured to prevent such manipulation.

If the accessory records the time of every measurement, it is simple to detect whether the user has turned back the clock to extend the usable life of the cartridge. But there may also be valid reasons to adjust the clock; for example, changing from daylight savings to standard time, or traveling into a different time zone. If the accessory's battery is removed, the RTC is reset and the microprocessor loses the elapsed time since the last test. One ideal solution is to provide the RTC with a dedicated backup battery, so that calendar time can be tracked reliably. In another implementation, because the RTC draws an extremely small amount of current, a large capacitor might also be used to supply the RTC with a reliable power source. However, either configuration adds cost and size to the device. Without access to a reliable, trusted clock, it is virtually impossible to prevent any abuse relating to any financial arrangement for use of the cartridge and device. With this in mind and having a goal of discourage cheating by making it as difficult as possible to manipulate the audio device, a number of options are feasible. One option is to monitor (1) the value of the RTC, (2) the value of the glucometer time-stamp, and (3) the time-stamp of the previously recorded test result. If the RTC is found to be invalid (e.g., it has been reset since the last use) then it is programmed with the greater of (2) or (3). When the RTC reaches a month, the cartridge is marked as expired.

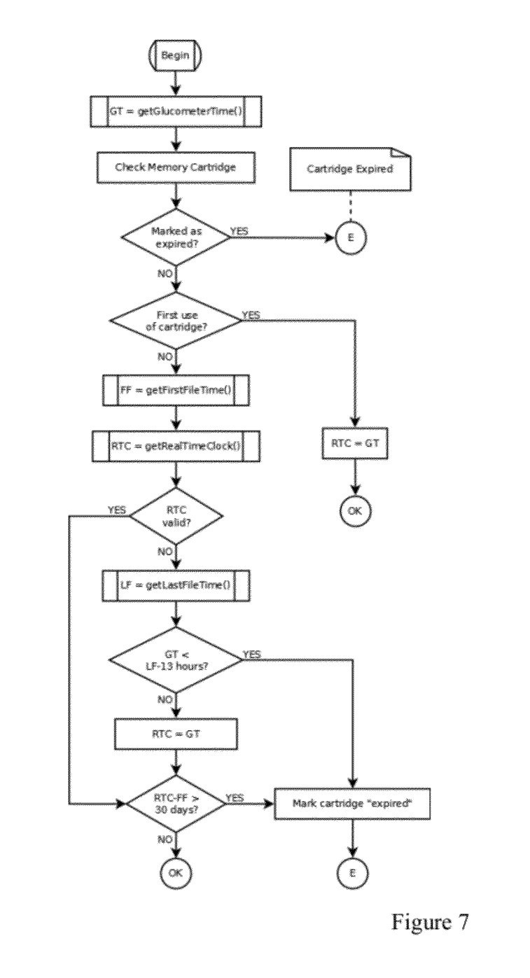

The flow diagram of FIG. 7 illustrates the algorithm described above. Extending the one month license period of a cartridge requires a user to set back the glucometer clock and remove the accessory batteries. If the authentication mechanism of the previous section is implemented, nothing can be done to reuse a cartridge that has already been marked as expired. Nonetheless, the method of FIG. 7 provides a small, simple, low cost solution to the problem of expiration, although a backup battery or capacitor may be used if desired.

As explained above, the memory cartridge used in the audio device has certain storage requirements. In particular, the memory cartridge must store one month's worth of test results. It must also store certain security data, such as whether the one month license has expired. Table 3 illustrates the structure of the cartridge file system, along with estimated file sizes.

TABLE 1
File system structure

| Item | Description | Size (bytes) |
|---|---|---|
| Data | Directory containing test results. | — |
| Results | Log file containing up to a months of | 18600 |
| | test results. | |
| battery_voltage | A file containing the current battery | 2 |
| | voltage | |
| Security | Directory containing security-related | — |
| | information. | |
| Sernum | Serial number of the matching | 8 |
| | accessory device. | |
| Locked | This file indicates whether the cartridge | 1 |
| | has expired. | |

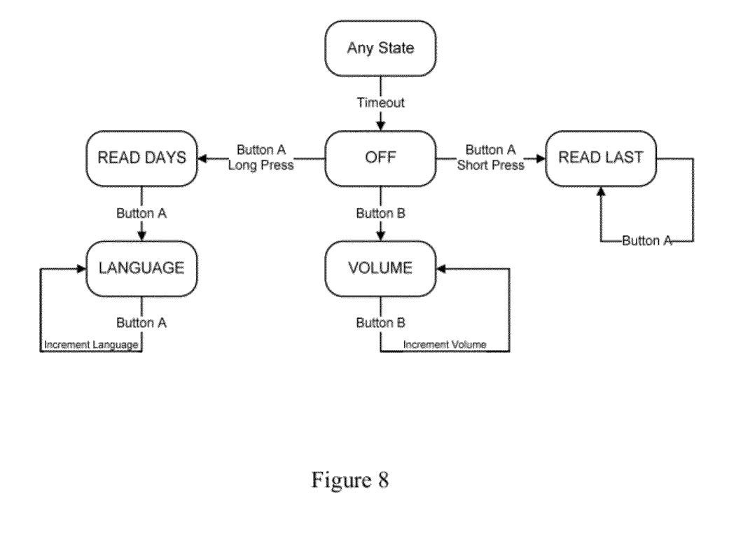

As explained above, the audio device includes a number of user interfaces, such as buttons for controlling output and audio prompts to inform the user. Optimally, to keep the user interface as simple as possible for users with visual impairment, only two buttons are used for input. The user may access the following functions through pressing one of these two buttons: (a) power on the device; (b) read aloud the most recent test result; (c) read aloud the current volume level; (d) set a new volume level; and (e) read aloud the days remaining on the cartridge. The diagram illustrated in FIG. 8 provides the menu navigation for using the buttons to control the device. A more detailed description of each state is provided in Table 4.

TABLE 2
User Interface States

| State | Description |
|---|---|
| OFF | This is the default state with the accessory powered |
| | off. All other states will enter the OFF state after a |
| | timeout. |
| READ LAST | Entered from the OFF state after a short press of |
| | button A. The last test result is retrieved from the |
| | glucometer and spoken aloud. Another press repeats |
| | the information. |
| READ DAYS | Entered from the OFF state after a long press of button |
| | A. The accessory reads aloud the number of days |
| | remaining on the cartridge. |
| LANGUAGE | Entered from READ DAYS after a press of button A. |
| | The Accessory changes and announces the new |
| | language. |
| VOLUME | Entered after a press of button B from OFF. The |
| | accessory increments the volume and announces the |
| | new volume level, “low-medium-high.” Each |
| | additional press of button B cycles through the |
| | available volume levels. |

The electronics will support the ability to place buttons on the tethering cable as an option. These buttons will be treated exactly as the buttons on the audio device itself and the microprocessor will not be able to determine whether a tether or device button was pressed.

The audio device also includes audio prompts to provide the user with other kinds of information. These situations are described below. For example, when the battery voltage falls below a minimum threshold, the audio device will announce “low battery” immediately after leaving the OFF state. When the cartridge usage has exceeded one month, the audio device will announce “cartridge expired” and return to the OFF state. When the audio device fails to authenticate the cartridge, it will announce “cartridge error” and return to the OFF state. When the reading from the glucometer indicates a checksum error, the accessory will announce “test error.” The only error which the glucometer indicates is a checksum error on the test results stored in its internal memory. When the accessory fails to communicate with the glucometer, it should announce “connection error” and remain in the READ LAST state. When the user short presses button A to activate the accessory, it should announce “downloading.”

The audio device can be programmed to work with any glucometer or only specific glucometers. The primary difference between the two is the requirement that additional memory be provided in the audio device to include the information needed to communicate with the glucometer. For example, the OneTouch Ultra2 glucometer uses a serial data protocol of 9600 baud, 8 data bits, 1 stop bit, no parity and supports six commands, described in Table 5.

TABLE 3
OneTouch Ultra2 serial commands.

| Command | Description |
|---|---|
| DM? | Returns the meter's firmware version and date code. |
| DM @ | Returns the meter's unique serial number. |
| DMF | Returns the current date and time according to the meter's |
| | clock. |
| DMP | Returns all measurement results (up to 500) stored in the |
| | meter's memory. |
| DMSU? | Returns the current units setting (“mg/dl” or “mmol/l”) of |
| | the meter. |
| DMST? | Returns the current clock format (“AM/PM” or “24:00”) of |
| | the meter. |

Each command must be preceded by a three-byte attention sequence, [DC1][CR][LF]. Of great interest here is the DMP command, which dumps all of the stored test measurements. When this command is sent to the meter, it responds with a header line plus one line for each test record. Each line is terminated by a carriage return and linefeed. The header has the following format:
P nnn, “ssssssssY”, “MG/DL” xxxx
   Where nnn indicates the total number of records to follow, ssssssss is the meter's eight-character serial number, and xxxx is a four-digit hexadecimal checksum. Each test record has the following format:
P “ddd”, “mm/dd/yy”, “hh:mm:ss”, “ggg”, “f”, “cc”, 00 xxxx
   Where ddd is the three-character abbreviation for day of week, mm/dd/yy represents the date, hh:mm:ss represents the time, and ggg is the three-digit decimal blood glucose measurement. The f and cc fields are comments set by the user at the time of testing, and xxxx is a four-digit hexadecimal checksum.

There are two additional pieces of information provided by the glucometer. If the character ‘c’ precedes the blood glucose measurement, it means that this was a control measurement for calibration purposes. If the character ‘?’ follows the blood glucose measurement, it means that the meter detected a possible data corruption condition when reading from its internal memory. However, this information is of limited use, since it is unlikely to happen during the normal life of the meter. No other error conditions are indicated by the published protocol.

The meter must be powered off before it will recognize the attention sequence and respond to commands. It may take up to 20 seconds for the meter to respond to commands. If there is no response after that time, the audio device should indicate an error condition to the user, reminding the user to power off the meter before proceeding.

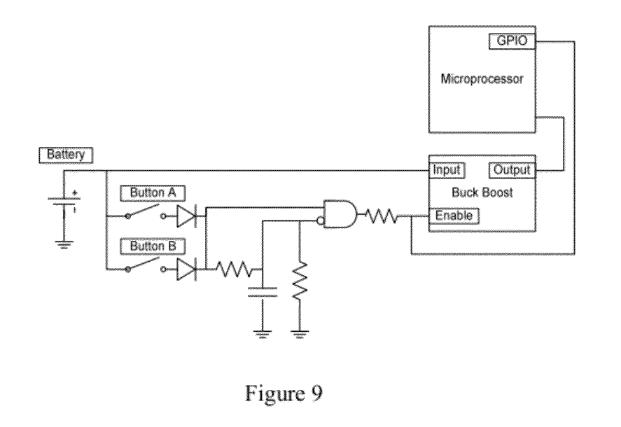

Referring to FIG. 9, the audio device also may be configured to be powered up and down with a user-activated button. Once turned on, the accessory would only need to communicate with the glucometer one time to gather the required information. One of the benefits of this method is that the accessory stays powered for the minimum amount of time, thus extending the battery life considerably. Additionally, there are no complex mechanical or electrical connections required between the glucometer and the accessory. Finally, the button allows the user to repeat the previous results at any time. It should be noted that the accessory can wake up the glucometer at any point without the user having to turn it on separately.

The audio device may contain multiple buttons either of which must be able to turn the device on. Additionally, the device may be resting against other objects which may cause one or both buttons to be permanently pressed. While in this condition the battery of the accessory cannot be drained using circuitry placed between these buttons and the buck boost converter. This circuitry is configured to limit the time which the buttons can keep the buck boost enabled. One example of such circuitry is shown in FIG. 9.

There are a variety of pushbuttons available on the market some of which are top push and some are side push. Either type may be suitable for use in audio device. Such push buttons are available, for example, from Omron Electronics.

Another hardware component in the audio device is the microprocessor. The microprocessor is typically selected based on a combination of factors: performance, memory, speed of implementation, low power, and low cost. In addition the microprocessor must have the peripherals needed to run the system. There are a wide variety of processor families. One suitable family of processors for use in the audio device is the LPC1700 family. The LPC1700 family allows DMA control over the audio DAC. The double buffer feature of this DAC can be used to eliminate the gaps, clicks, and pops that might otherwise occur as the DMA is reloaded between transfers. Further, if additional memory is needed, other pin comparable processors within the same family can easily be utilized.

Also of importance in the audio device is the speaker. While numerous speakers are available on the market, the size should be in the range of 13 mm×18 mm; 14 mm×20 mm; or mm×11 mm or 13 mm diameter. Such sizes are commercially available. The speaker should be selected to provide quality audio feedback.

Another component used in the device is the audio amplifier that drives the speaker. Suitable audio amplifiers for the audio device may have an input voltage of 2.2 to 5.5 volts, 2.4 to 5.5 volts, or 4-12 volts. The output power may be 325 mW, 500 mW, or 700 mW. Manufacturers of such audio amplifiers are known in the art and include National, Rohm, ST Micro and Texas Instruments.

The audio device also should include electrostatic discharge (ESD) protection between the audio device and the glucometer. Protection against 12 kV electrostatic discharge is sufficient for this project as it exceeds the ESD levels typically discharged by human contact. The physical characteristics of the coin cell battery mechanically provides protection against inserting the battery backwards.

Another important component of the audio device is the memory cartridge holder. A number of sockets that will accept a memory token are available on the market. Options include panel mount receptacles, normal receptacles, surface mount and through hole options. One commercially available socket suitable for the memory cartridge holder is the DataKey socket which accepts memory tokens. A mechanical reinforcement can be used that resists the force of the user inserting and removing the memory cartridge. This will enhance the reliability and longevity of the audio device.

The power for the audio device may be provided by batteries to provide portability to the device. There are a number of battery technologies and sizes that may be used in the device. In one implementation, the circuitry needed for the audio device requires a 3 volt supply. If the regulator selected for use with the device has a dropout voltage of 100 mA, the voltage supplied by the battery must be at least 3.1 volts.

The different battery technologies provide different voltages and energy densities. One option is to use a 3.6 volt lithium battery. This battery can by itself supply the desired voltage to the accessory. Another option is to use two or more alkaline AAA batteries in series with an optional buck boost converter capable of boosting the battery voltage up to that needed by the audio device.

Finally, the majority of the hardware will be mounted on a printed circuit board (PCB). Printed circuit boards are well known in the art and can be configured to fit within a plastic housing of the audio device.

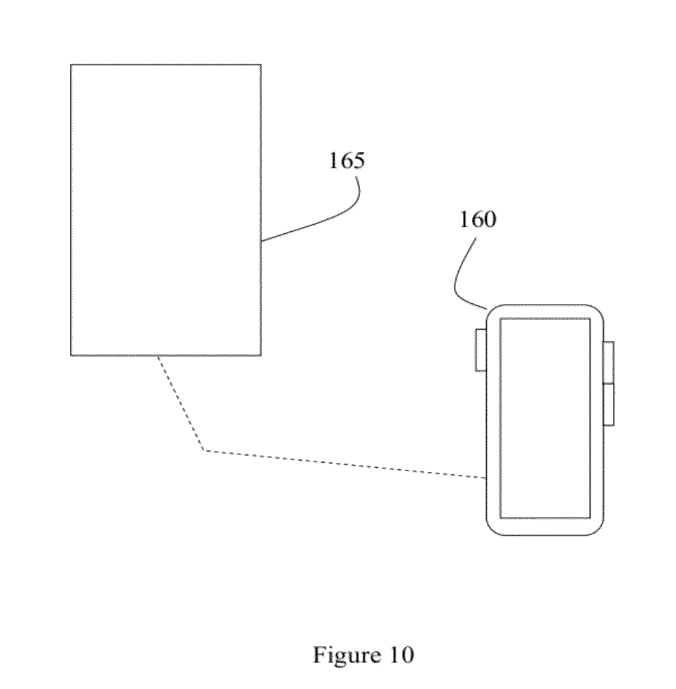

As explained above, in an alternative embodiment, the speech module and the characteristics (e.g., functions) described above for the speech module are implemented as an application on a smart phone that is connected to the glucometer. As illustrated in FIG. 10, the speech module implemented as a mobile phone 160 is connected or tethered to the glucometer 165 by any data transfer means, such as IR, bluetooth or a cable/wire (e.g., a USB cable). The user then can operate take a blood glucose measurement with the glucometer and the application programmed on the mobile phone will receive the data, or a portion of the data, generated by the glucometer. The data then is “spoken” or otherwise emitted by the speaker on the mobile phone such that the user can hear the measurement. The inventors believe that by providing the glucose reading data to the cell phone, which most individuals own already, the user will find it easier to more accurately know their blood glucose value. Further, while the separate speech module described above advantageously provides a universal device permitting the user to hear their blood glucose measurement, for some users the advantage of using an already existing and owned device, i.e., a mobile phone, provides additional advantages. For example, the user does not need to carry or purchaser an additional product. The user also will be very familiar with the mobile phone by using the phone daily. Based on these and other reasons, the inventors have developed the mobile phone application of a speech module for use with a glucometer.

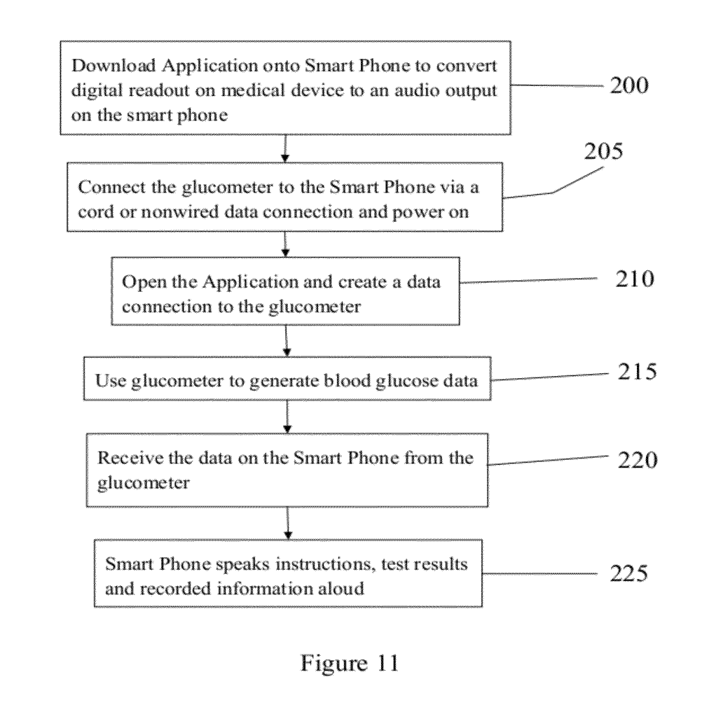

FIG. 11 is a flow chart that illustrates the steps for generating an audio signal from the speech module with a smart phone. The Patient downloads an “App” on his smart phone that will convert the digital read out on the glucometer to an audio output on the smart phone (step 200) and connects the smart phone to the glucometer (step 205). The connection powers on the “App” and opens the “App” on the smart phone (step 210). The Patient clicks “connect to the glucometer” on the smart phone or speaks to the phone and says “connect”. The Patient enters data, for example glucose strips placed in the glucometer to generate blood glucose data (step 215). After the input of the strip the glucometer generates blood glucose data and sends the data to the smart phone via IR, bluetooth or a cable (step 220). The data is processed in the smart phone and will output as auditory communications one or more of instructions, test results, and the recorded information to the user (step 225). In general, the application will have all of the capabilities that are found on the separate speech module.

In addition to the capabilities found in the stand alone speech module, the application may also aid the visually impaired by providing a screen that is easy for the user to navigate. For example, the user may need to use the following functions: volume up, volume down, repeat reading, input audio. To implement this for the visually impaired, the application may divide the screen into four quadrants of similar size. The upper two quadrants may be arranged such that the left quadrant is volume down and the right quadrant is volume up. The bottom left quadrant can be repeat reading and the bottom right quadrant input audio. The software of the application also can be configured such that a first light touch of the quadrant states the function of the button while a second touch or a firm first touch of the quadrant activates the function. In this manner, the visually impaired user can more easily control the operations of the device.

The speech module application for a mobile phone may in some implementations require the glucometer to include a separate module within or added on to the glucometer for the purpose of transmitting the data by IR or bluetooth. For example, an OEM glucometer can be developed and purchased that has bluetooth and/IR capability. Such a glucometer will tether or communicate with the mobile phone using the bluetooth or IR capabilities of both the glucometer and the mobile phone. However, if the glucometer does not have IR or bluetooth capabilities, the user can attach a separate IR or bluetooth transmitter to the glucometer. For example, the transmitter can be attached to a USB port on the glucometer and then when activated, will transmit the data. Therefore, in another embodiment of the invention, there is provided a combination of a glucometer with a built in IR and/or bluetooth capability and a software application that can be downloaded to a smart phone to give the user the ability to quickly and easily communicate with the glucometer to have an auditory output of the blood glucose measurement value.

It also should be understood that while the speech module application described above was specified to be used with a blood glucometer, the application can be configured to work with any medical device that performs a reading. Preferably, the medical device will be one that is used by an individual who will want to know the measured values. Such medical devices include blood pressure measuring devices, IV devices, thermometers, etc. In particular, medical devices that will be advantageously improved by using a speech module on a Smart Phone include any medical device that measures a variable in a home environment.

While several particular forms of the invention have been illustrated and described, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A speech module for attaching to a medical device and providing a clear and accurate auditory component to the device comprising:
(a) an audible signal generator;
(b) a recording means for recording data virtually simultaneously with daily activities stored for later viewing;
(c) a port or a connector for interchangeably connecting the module to the medical device;
(d) a control unit comprising an on/off switch to start or stop the module operation, a switch to control the volume, and a button to repeat the message emitted from the speaker

2. The speech module of claim 1, wherein the audible signal generator includes a voice processing means and a synthesizer.

3. The module of claim 1, wherein the recording means records auditory information to the speech module.

4. The speech module of claim 2, wherein the voice processing means is configured to provide as output one or more of instructions, test results and recorded information.

5. The speech module of claim 1, wherein the module further includes a visual display.

6. The speech module of claim 5, wherein test results and recorded information are provided as an auditory output and a display on the visual display.

7. The speech module of claim 1, wherein the module further includes a built-in microphone for receiving auditory input.

8. The speech module of claim 7, wherein the auditory input can be recorded in a way or other format.

9. The speech module of claim 1, wherein the medical device is a glucose monitor, blood pressure monitor, or a thermometer.

10. The speech module of claim 1, wherein the speech module is connected to the medical device by a connecting means.

11. The speech module of claim 10, wherein the connecting means is one or more of a connecting wire, blue tooth or Infra-red radiation.

12. The speech module of claim 1, wherein the module includes a port for connecting to a port in the medical device through a connecting wire.

13. The speech module of claim 1, wherein the module further includes a memory chip for acquiring and storing data, and the chip includes counts that reduces by one unit for every usage of the medical device.

14. The speech module of claim 1, wherein the module is compatible with more than one brand of medical device.

15. A software application for providing a speech module on a smart phone for communicating with a medical device to provide a clear and accurate auditory output of the medical device on the smart phone, the application comprising:
(a) code for turning on the software application on the smart phone;
(b) code for communicating with the medical device to receive data from the medical device;
(c) code for recording and storing the data on the medical device;
(d) code for providing as an auditory output from the smart phone the data received from the medical device;
(e) code for permitting an auditory input to the smart phone through a microphone on the smart phone;

16. The software application of claim 15, wherein the software is configured to converts the digital readout on the medical device to an audio output from the smart phone.

17. The software application of claim 15, wherein the software is programmed for the smart phone to received data from the medical device via blue tooth connection, IR, or a connecting wire.

18. The software application of claim 15, wherein the software is programmed to provide a user the ability to e-mail, download and/or view the data received from the medical device or data input by a user.

19. The software application of claim 15, wherein the software is configured to include counts that reduces by one unit for every usage of the medical device transmitted to the smart phone.

20. A method for operating an integrated speech module configured to provide auditory component to a medical device, the method comprising attaching the integrated speech module, including a voice processing means, to a medical device, receiving and processing the signal in the voice processing means, converting the signal into audio signal for the speaker and transmitting the signal to the speaker as audible instructions, test results and recorded information to the user, the user pressing the repeat button to repeat the measurement emitted from the speaker.
